(19) United States
(12) Patent Application Publication
(10) Pub. No.: US 2007/0064183 A1
(43) Pub. Date: Mar. 22, 2007

(54) Transflective liquid crystal display device and display panel therefor

(76) Inventors: Yi-Pai Huang, Hsinchu City (TW); Han-Ping Shieh, Hsinchu City (TW); Meng-Xi Chan, Hsinchu City (TW)

Correspondence Address: J C PATENTS, INC., 4 VENTURE, SUITE 250, IRVINE, CA, 92618, US

(21) Appl. No.: 11/233,627

(22) Filed: Sep. 22, 2005

(51) Int. Cl. G02F 1/1335

(52) U.S. Cl. 349/114

(57) ABSTRACT

A transflective liquid crystal display panel comprises a plurality of pixel units. Each pixel unit comprises a first substrate, a second substrate and a cholesteric liquid crystal layer. The first substrate has a reflective region and a transparent region, and the first substrate comprises a first electrode layer covering the reflective region and the transparent region. The second substrate comprises a reflector and a second electrode layer, in which the reflector is aligned with the transparent region of the first substrate, and the reflector is covered by the second electrode layer. The cholesteric liquid crystal layer is disposed between the first substrate and the second substrate. Each pixel unit of the liquid crystal display panel displays a bright state and a dark state by the above mentioned reflector, such that the cholesteric liquid crystal can be applied to the transflective liquid crystal display.

### BACKGROUND OF THE INVENTION

1. Field of the Invention

The present invention generally relates to a liquid crystal display panel and a liquid crystal display. More particularly, the present invention relates to a transflective liquid crystal display panel and a transflective liquid crystal display.

2. Description of Related Art

The liquid crystal displays (LCD) are applied to a large number of personal digital assistants (PDA), notebook computers and the like. The key point of the development of the LCD emphasizes the reduction of power consumption and better display quality. The cholesteric LCD has a characteristic of bistable, and a voltage is applied to the display when updating the frame. Therefore, the cholesteric LCD has an advantage of power saving.

Besides, the transflective liquid crystal display is a display which combines a transmissive LCD with a reflective LCD. For the transflective LCD, when the light in the external environment is sufficient, the external light can be used as a light source in order to save the power consumption, otherwise, a backlight module is provided in order to enhance the brightness of the frame. Therefore, the transflective LCD has better display quality in any environment.

In addition, the cholesteric liquid crystal molecules have the characteristic of bistable. Therefore, the power consumption of the cholesteric LCD is less than that of the general twist nematic LCD (TN-LCD). But the general cholesteric LCD is a reflective LCD, such that the display quality is worse if the light in the external environment is not sufficient.

The transflective LCD were disclosed in the Int'l Display Workshop(2001), p. 129, by Yuzo Hisatake et al, (Toshiba) and SID'00, p. 742, by Rob van Asselt et al, (Philips). The transflective cholesteric LCD disclosed in the above mentioned papers utilizes the cholesteric liquid crystal molecules as a reflective layer but not as a light switch.

Because if the cholesteric liquid crystal molecules are used as the light switches in the conventional transflective LCD, whether a voltage is applied to the display or not, the display always performs a light state after the light provided from the external environment and the backlight module travels through cholesteric liquid crystal molecules. Therefore, the transflective effect of the cholesteric LCD is not put into full play, such that the present cholesteric LCD operates in a reflective mode.

The technologies for manufacturing a color cholesteric LCD were disclosed in the U.S. Pat. Nos. 6,377,321, 6,061,107 and 5,949,513. The liquid crystal display disclosed in U.S. Pat. No. 6,377,321 makes use of stacked red, green and blue liquid crystal layers to achieve full color display. In the cholesteric LCD disclosed in U.S. Pat. No. 6,061,107, the mixture of red light, green light and blue light is achieved by illuminating the liquid crystal layer with the UV light of different intensity and controlling the helical pitch of the liquid crystal molecules. Besides, in the multi-color LCD disclosed in U.S. Pat. No. 5,949,513, different chirals are added in the liquid crystal layer in order to control the helical pitch of the liquid crystal molecules, such that the mixture of red light, green light and blue light can be achieved. However, the above mentioned patents are the reflective liquid crystal displays, not the transflective liquid crystal displays.

Therefore, the solution of how to use the cholesteric liquid crystal as the light switches of the transflective LCD is highly desired in the technology of transflective LCD.

### SUMMARY OF THE INVENTION

A main purpose of the present invention is to provide a transflective LCD device and display panel therefor, to overcome the condition that the cholesteric liquid crystal can not be used as the light switch of the transflective LCD.

As embodied and broadly described herein, the present invention provides a transflective LCD panel comprising a plurality of pixel units. Each pixel unit comprises a first substrate, a second substrate and a cholesteric liquid crystal layer. The first substrate has a reflective region and a transparent region. The first substrate comprises a first electrode layer disposed thereon covering the reflective region and the transparent region. The second substrate comprises a reflector and a second electrode layer disposed thereon, in which the reflector is aligned with the transparent region of the first substrate, and the reflector is covered by the second electrode layer. The cholesteric liquid crystal layer is disposed between the first substrate and the second substrate.

According to one embodiment of the present invention, the birefringence difference (Δn) of a liquid crystal material of the cholesteric liquid crystal layer is between 0.15 and 0.8.

According to one embodiment of the present invention, the second substrate further comprises a color filter layer disposed thereon. The color filter layer is aligned with the reflective region of the first substrate, and the color filter layer is covered with the second electrode layer.

According to one embodiment of the present invention, a material of the reflector comprises metal.

According to one embodiment of the present invention, the reflector comprises an insulating layer and a metal layer covering the insulating layer.

According to one embodiment of the present invention, a light absorbing layer is arranged on the reflective region of the first substrate.

According to one embodiment of the present invention, the first substrate further comprises an active device disposed thereon. The active device is electrically connected to the first electrode layer.

According to one embodiment of the present invention, the transflective LCD panel further comprises a first alignment layer and a second alignment layer. The first alignment layer is disposed between the first electrode layer and the cholesteric liquid crystal layer, and the second alignment layer is disposed between the second electrode layer and the cholesteric liquid crystal layer.

According to one embodiment of the present invention, a material of the first electrode layer comprises indium tin oxide or indium zinc oxide.

According to one embodiment of the present invention, a material of the second electrode layer comprises indium tin oxide or indium zinc oxide.

The present invention further provides a transflective LCD comprising a transflective LCD panel and a backlight module. The transflective LCD panel has a front surface and a back surface. The backlight module is arranged on the back surface of the transflective LCD panel. The transflective LCD panel comprises a plurality of pixel units, and each pixel unit comprises a first substrate, a second substrate and a cholesteric liquid crystal layer. The first substrate has a reflective region and a transparent region. The first substrate comprises a first electrode layer disposed thereon covering the reflective region and the transparent region. The second substrate comprises a reflector and a second electrode layer disposed thereon, in which the reflector is aligned with the transparent region of the first substrate, and the reflector is covered by the second electrode layer. The cholesteric liquid crystal layer is disposed between the first substrate and the second substrate.

According to one embodiment of the present invention, the birefringence difference (Δn) of a liquid crystal material of the cholesteric liquid crystal layer is between 0.15 and 0.8.

According to one embodiment of the present invention, the second substrate further comprises a color filter layer disposed thereon. The color filter layer is aligned with the reflective region of the first substrate, and the color filter layer is covered with the second electrode layer.

According to one embodiment of the present invention, a material of the reflector comprises metal.

According to one embodiment of the present invention, the reflector comprises an insulating layer and a metal layer covering the insulating layer.

According to one embodiment of the present invention, a light absorbing layer is arranged on the reflective region of the first substrate.

According to one embodiment of the present invention, the first substrate further comprises an active device disposed thereon. The active device is electrically connected to the first electrode layer.

According to one embodiment of the present invention, the transflective LCD panel further comprises a first alignment layer and a second alignment layer. The first alignment layer is disposed between the first electrode layer and the cholesteric liquid crystal layer, and the second alignment layer is disposed between the second electrode layer and the cholesteric liquid crystal layer.

In the transflective LCD device and display panel therefor of the present invention, the second substrate of each pixel unit comprises a reflector thereon and the reflector is aligned with the transparent region of the first substrate. The transflective LCD device using the choleteric liquid crystal as the light switch has the advantages of transflection through the arrangement of the reflector.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a top view showing a transflective LCD panel according to a preferred embodiment of the present invention.

FIG. 2 is a cross sectional view showing the pixel unit shown in FIG. 1 along the cutting line A-A′.

FIG. 3 is a schematic diagram showing the pixel unit shown in FIG. 2 without the application of a voltage.

FIG. 4 is a schematic diagram showing the pixel unit shown in FIG. 2 with the application of a voltage.

FIGS. 5A to 5D are schematic diagrams showing the arrangements of the reflective region and the transparent region of the pixel unit according to the present invention.

FIG. 6 is a schematic diagram showing a transflective LCD device according to the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

Transflective Liquid Crystal Display Panel

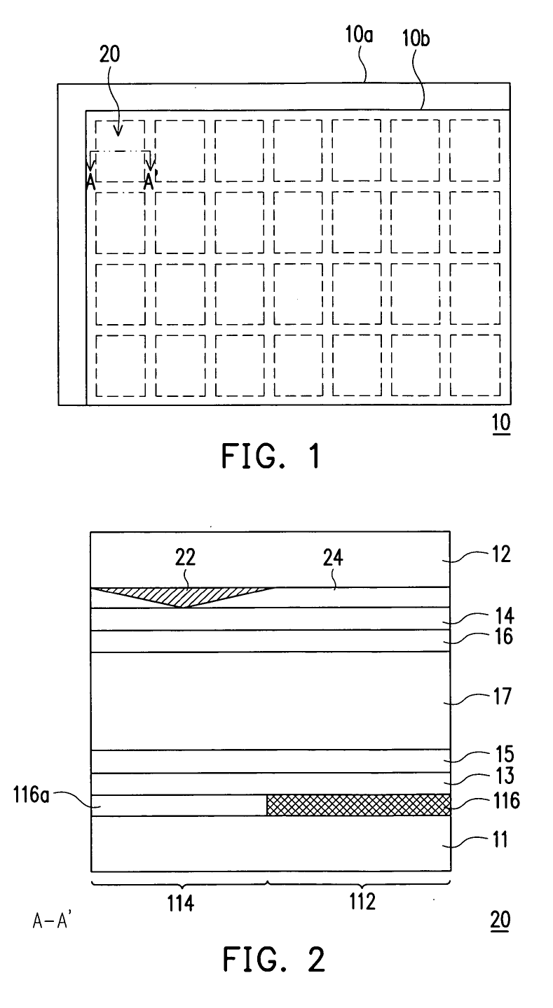

FIG. 1 is a top view showing a transflective LCD panel according to a preferred embodiment of the present invention.

Please refer to FIG. 1, the transflective LCD panel 10 of the present invention comprises two substrates 10a, 10b and a liquid crystal layer (not shown) disposed between the substrates 10a, 10b. The transflective LCD panel 10 comprises a plurality of pixel units 20 while theses pixel units 20 are the basic display units of the transflective LCD panel 10.

FIG. 2 is a cross sectional view showing the pixel unit shown in FIG. 1 along the cutting line A-A′. Please refer to FIG. 2, each pixel unit 20 of the transflective LCD panel 10 comprises a first substrate 11, a second substrate 12, a first electrode layer 13, a second electrode layer 14 and a cholesteric liquid crystal layer 17. The first substrate 11 and the second substrate 12 can be glass substrates for example. The first substrate 11 has a reflective region 112 and a transparent region 114 while the first electrode layer 13 covers the reflective region 112 and the transparent region 114. The material of the first electrode layer 13 comprises indium tin oxide (ITO) or indium zinc oxide (IZO) for example. In a preferred embodiment, a light absorbing layer 116 is arranged on the reflective region 112, and a transparent film layer 116a is arranged on the transparent region 114 for example.

Besides, the second substrate 12 comprises a reflector 22 and a second electrode layer 14 disposed thereon. The reflector 22 is aligned with the transparent region 114 of the first substrate 11. In a preferred embodiment, the reflector 22 can be made of metal for example, and the method of fabricating the reflector 22 comprises a deposition process first and then a photolithography and etching process, or a deposition process with a shadow mask. In another preferred embodiment, the reflector 22 is made of a photoresist material and a metal layer for example, and the method of fabricating the reflector 22 comprises the following steps. First, a photoresist layer is formed and then the photoresist layer is patterned by a photolithography process. Next, a metal layer for reflecting the light is formed on the surface of the photoresist layer to form the reflector 22. Particularly, the contour of the patterned photoresist layer may be a prism, a dual-prism, a sphere, a non-sphere and the like by laser etching or reflowing the photoresist layer.

Besides, the second electrode layer 14 covers the reflector 22. The material of the second electrode layer 14 comprises indium tin oxide (ITO) or indium zinc oxide (IZO) for example. In a preferred embodiment, the second substrate 12 further comprises a color filter layer 24 disposed thereon while the color filter layer 24 is aligned with the reflective region 112 of the first substrate 11 and the second electrode layer 12 covers the reflector 22 and the color filter layer 24. The color filter layer 24 comprises a red filter layer, a green filter layer and a blue filter layer for example.

In a preferred embodiment, each pixel unit 20 further comprises a first alignment layer 15 and a second alignment layer 16 for example. The first alignment layer 15 and the second alignment layer 16 cover the first electrode layer 13 and the second electrode layer 14 respectively.

Further, the cholesteric liquid crystal layer 17 is disposed between the first alignment layer 15 and the second alignment layer 16. The cholesteric liquid crystal layer 17 may comprise dextro or laevo cholesteric liquid crystals.

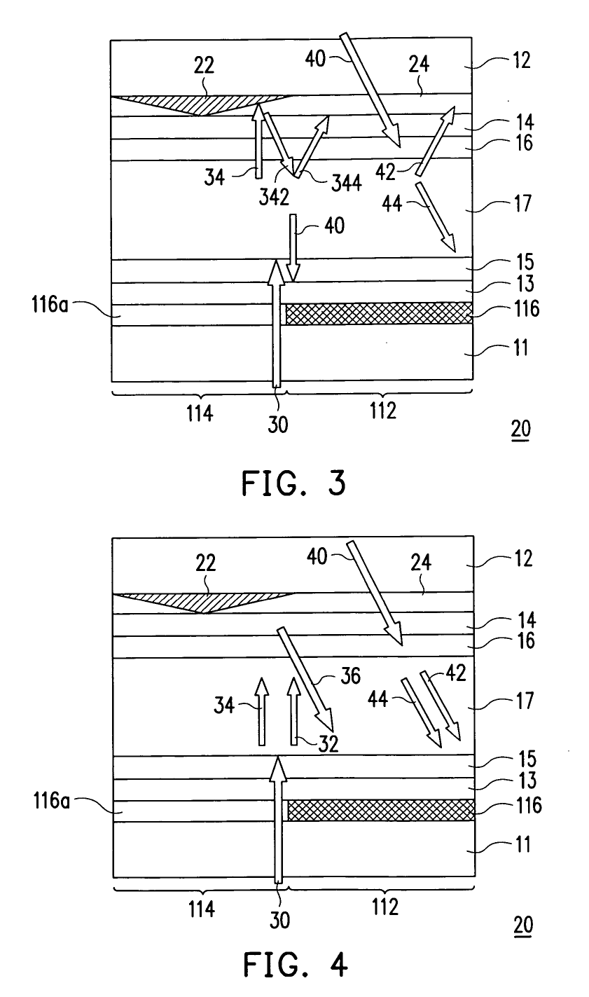

FIG. 3 is a schematic diagram showing the pixel unit shown in FIG. 2 without the application of a voltage. Please refer to FIG. 3, under the condition that a voltage is not applied to the pixel unit, the cholesteric liquid crystal layer 17 does not rotate, such that the light 30 provided from the backlight module would travel through the first substrate 11, the transparent region 114 and arrive the cholesteric liquid crystal layer 17. The dextro cholesteric liquid crystals are taken as an example in the following. Because the cholesteric liquid crystal layer 17 comprises dextro cholesteric liquid crystals, the component of right-handed circularly polarized light 32 provided from the backlight module would be reflected by the cholesteric liquid crystal layer 17 and could not be transmitted upward. Therefore, the user can not see the above mentioned component of right-handed circularly polarized light 32. On the other hand, the component of left-handed circularly polarized light 34 provided from the backlight module travels through the cholesteric liquid crystal layer 17 and illuminates the reflector 22. After the component of left-handed circularly polarized light 34 is reflected by the reflector 22, the left-handed polarization property of the component of left-handed circularly polarized light 34 is transformed into left-handed polarization, and a reflected light 342 is formed and returns to the cholesteric liquid crystal layer 17. Next, the reflected light 342 is reflected by the cholesteric liquid crystal layer 17 to form a reflected light 344, and then the reflected light 344 travels through the color filter layer 24, such that the user can see the above mentioned component of left-handed circularly polarized light 34.

On the other hand, the light 40 provided from the external environment arrives the cholesteric liquid crystal layer 17 through the second substrate 12, the component of right-handed circularly polarized light 42 of the light 40 is reflected by the cholesteric liquid crystal layer 17 and travels through the color filter layer 24, such that the user can see the above mentioned component of right-handed circularly polarized light 42. Further, the component of left-handed circularly polarized light 44 of the light 40 travels through the cholesteric liquid crystal layer 17 and is transmitted forward. Finally, the component of left-handed circularly polarized light 44 is absorbed by the light absorbing layer 116, such that the user can not see the above mentioned component of left-handed circularly polarized light 44. In summary, the user can see the component of left-handed circularly polarized light 34 of the light 30 provided from the backlight module and the component of right-handed circularly polarized light 42 of the light 40 provided from the external environment. Therefore, the pixel unit 20 displays a bright state without the application of a voltage.

FIG. 4 is a schematic diagram showing the pixel unit shown in FIG. 2 with the application of a voltage. Please refer to FIG. 2, when a voltage is applied to the pixel unit 20, the cholesteric liquid crystal layer 17 would rotate to a clear homeotropic state. The cholesteric liquid crystal layer 17 with the clear homeotropic state does not reflect the polarized light optionally, and therefore all light is transmitted. After the light 30 provided from the backlight module travels through the first substrate 11 and the transparent region 114, and arrives the cholesteric liquid crystal layer 17, the component of right-handed circularly polarized light 32 and left-handed circularly polarized light 34 travel through the cholesteric liquid crystal layer 17 and illuminate the reflector 22, to form a reflected light 36 returning to the cholesteric liquid crystal layer 17. Next, the reflected light 36 travels through the cholesteric liquid crystal layer 17 and is absorbed by the light absorbing layer 116. Therefore, the user can not see the light 30 provided from the backlight module. On the other hand, after the light 40 provided from the external environment travels through the second substrate 12 and arrives the cholesteric liquid crystal layer 17, the component of right-handed circularly polarized light 32 and left-handed circularly polarized light 34 travel through the cholesteric liquid crystal layer 17 and are absorbed by the light absorbing layer 116. Therefore, the user can not see the light 40 provided from the external environment. In summary, when a voltage is applied to the pixel unit 20, the user can not see the light 30 provided from the backlight module and the light 40 provided from the external environment, and therefore the pixel unit 20 displays a dark state. Thus, the transflective cholesteric LCD device of the present invention can display a dark state and a bright state, and it makes use of the cholesteric liquid crystals as the light switches of the transflective LCD device. Note that when a driving voltage is applied to the pixel unit 20, the active driving or the passive driving technology can be used. In a preferred embodiment, the first substrate 11 of each pixel unit further comprises an active device (not shown) disposed thereon, and the active device may be a thin film transistor for example. The thin film transistor is electrically connected to the first electrode layer 13 in order to transmit a driving voltage to the pixel unit 20, to perform the active driving.

Note that the band spectrum of the reflected light of the cholesteric liquid crystal molecules can be calculated according to the formula Δλ=p×Δn, where “p” is the helical pitch of the cholesteric liquid crystal molecules, and “Δn” is the birefringence difference of the cholesteric liquid crystal molecules. Therefore, the band spectrum of the reflected light can be increased by using the cholesteric liquid crystals having higher birefringence difference. In a preferred embodiment, the birefringence difference of the cholesteric liquid crystals is between 0.15 and 0.8. It means that the invention may utilize narrow band cholesteric liquid crystals (Δn=0.15˜0.5) or wide band cholesteric liquid crystals (Δn=0.5˜0.8). It should be noted that the band spectrum of the reflected light of the cholesteric liquid crystals whose birefringence difference is between 0.5 and 0.8 covers the visible spectrum from 450 nm to 650 nm. Therefore, the reflected light is white light. If the color filter layer 24 is not arranged on the second substrate 12, the liquid crystal display panel composed of the above mentioned pixel units 20 is a black-and-white display panel. On the other hand, if the color filter layer 24 is arranged on the second substrate 12, the liquid crystal display panel composed of the above mentioned pixel units 20 is a color display panel.

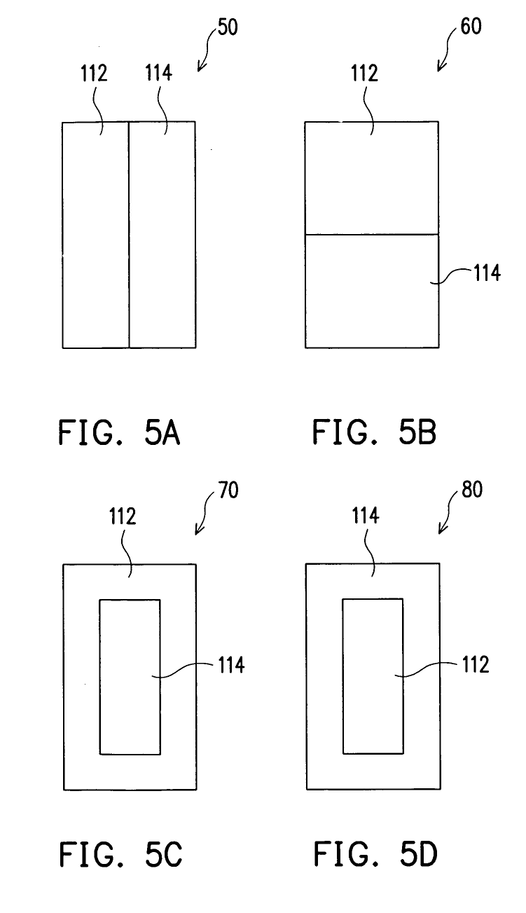

Note that each pixel unit of the present invention comprises a reflective region and a transparent region while the arrangement of the reflective region and the transparent region is not limited in the present invention. The preferred embodiments are taken as examples in the following. FIGS. 5A to 5D are schematic diagrams showing the arrangements of the reflective region and the transparent region of the pixel unit according to the present invention. Please refer to FIG. 5A, the pixel unit 50 is divided into a reflective region 112 and a transparent region 114 along its longer side. Please refer to FIG. 5B, the pixel unit 60 is divided into a reflective region 112 and a transparent region 114 along its shorter side. Please refer to FIG. 5C, the pixel unit 70 is divided into a reflective region 112 and a transparent region 114 where the transparent region 114 is surrounded by the reflective region 112. Please refer to FIG. 5D, the pixel unit 80 is divided into a reflective region 112 and a transparent region 114 where the reflective region 112 is surrounded by the transparent region 114.

Transflective Liquid Crystal Display Device

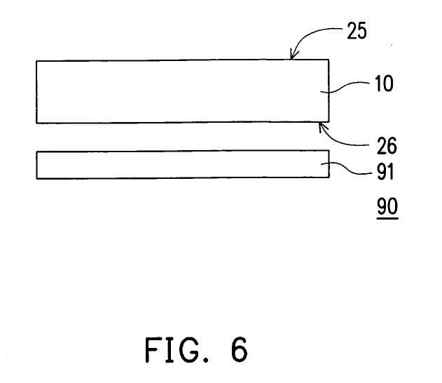

FIG. 6 is a schematic diagram showing a transflective LCD device according to the present invention. Please refer to FIG. 6, the transflective LCD device 90 of the present invention comprises a transflective LCD panel 10 and a backlight module 91. The transflective LCD panel 10 has a front surface 25 and a back surface 26 while the backlight module 91 is arranged on the back surface 26 of the transflective LCD panel 10. The backlight module 91 can be any conventional backlight module such as a direct type or a side type backlight module. The top view of the transflective LCD panel 10 is shown in FIG. 1, and the cross sectional view of each pixel unit of the transflective LCD panel 10 is shown in FIG. 2. The transflective LCD panel 10 and the pixel unit have been discussed before, and they are not repeated herein.

It should be noted that the transflective LCD device 90 of the present invention does not need any polarizer. Therefore, compared with the twist nematic LCD (TN-LCD) and the super twist nematic LCD (STN-LCD), the transflective LCD device 90 of the present invention has better light utilization rate.

In an embodiment, if the elements of the transflective LCD device 90 satisfy the following conditions to form a black-and-white display device where the dextro cholesteric liquid crystals are adapted for the cholesteric liquid crystal layer, the birefringence difference (Δn) is 0.6 and the second substrate does not comprise a color filter layer, then the light utilization rate of the LCD device is about 50%. In addition, if the second substrate comprises the color filter layer in order to form a color display device, its light utilization rate is about 16.7%. Compared with the conventional thin film transistor liquid crystal display (TFT-LCD) having 12% light utilization rate, the transflective LCD device 90 has higher light utilization rate.

In summary, the transflective liquid crystal display device and display panel of the present invention have the following characteristics and advantages:

Because the invention comprises the reflector, therefore, the cholesteric liquid crystal can be used as the light switches to form the transflective liquid crystal display device and the display panel therefore.

The transflective mode is adapted in the present invention, therefore, the display device has good display quality whether the light provided from the external environment is sufficient or not.

The invention utilizes the cholesteric liquid crystals having the characteristic of bistable as the light switches, and the voltage is applied to the display device only when updating the frame. Thus, the transflective liquid crystal display device and display panel of the present invention have the advantage of power saving.

The invention utilizes the cholesteric liquid crystals as the light switches, and it does not need the polarizer. Therefore, the invention has higher light utilization rate.

One of the preferred embodiments utilizes the cholesteric liquid crystals having higher birefringence difference and comprises the color filter layer, therefore, the display device is a full color display.

It will be apparent to those skilled in the art that various modifications and variations may be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A transflective liquid crystal display panel, comprising a plurality of pixel units, each pixel unit comprising:
a first substrate having a reflective region and a transparent region, the first substrate comprising a first electrode layer disposed thereon covering the reflective region and the transparent region;
a second substrate comprising a reflector and a second electrode layer disposed thereon, wherein the reflector is aligned with the transparent region of the first substrate, and the reflector is covered by the second electrode layer; and
a cholesteric liquid crystal layer disposed between the first substrate and the second substrate.

2. The transflective liquid crystal display panel according to claim 1, wherein the birefringence difference (Δn) of a liquid crystal material of the cholesteric liquid crystal layer is between 0.15 and 0.8.

3. The transflective liquid crystal display panel according to claim 1, wherein the second substrate further comprising a color filter layer disposed thereon, the color filter layer being aligned with the reflective region of the first substrate, and the color filter layer being covered with the second electrode layer.

4. The transflective liquid crystal display panel according to claim 1, wherein a material of the reflector comprises metal.

5. The transflective liquid crystal display panel according to claim 1, wherein the reflector comprises an insulating layer and a metal layer covering the insulating layer.

6. The transflective liquid crystal display panel according to claim 1, wherein a light absorbing layer is arranged on the reflective region of the first substrate.

7. The transflective liquid crystal display panel according to claim 1, wherein the first substrate further comprises an active device disposed thereon, and the active device is electrically connected to the first electrode layer.

8. The transflective liquid crystal display panel according to claim 1, further comprising a first alignment layer and a second alignment layer, the first alignment layer is disposed between the first electrode layer and the cholesteric liquid crystal layer, and the second alignment layer is disposed between the second electrode layer and the cholesteric liquid crystal layer.

9. The transflective liquid crystal display panel according to claim 1, wherein a material of the first electrode layer comprises indium tin oxide or indium zinc oxide.

10. The transflective liquid crystal display panel according to claim 1, wherein a material of the second electrode layer comprises indium tin oxide or indium zinc oxide.

11. A transflective liquid crystal display device, comprising:
a transflective liquid crystal display panel having a front surface and a back surface, the transflective liquid crystal display panel comprising a plurality of pixel units, and each pixel unit comprising:
a first substrate having a reflective region and a transparent region, the first substrate comprising a first electrode layer disposed thereon covering the reflective region and the transparent region;
a second substrate comprising a reflector and a second electrode layer disposed thereon, wherein the reflector is aligned with the transparent region of the first substrate, and the reflector is covered by the second electrode layer; and
a cholesteric liquid crystal layer disposed between the first substrate and the second substrate; and
a backlight module arranged on the back surface of the transflective liquid crystal display panel.

12. The transflective liquid crystal display device according to claim 11, wherein the birefringence difference (Δn) of a liquid crystal material of the cholesteric liquid crystal layer is between 0.15 and 0.8.

13. The transflective liquid crystal display device according to claim 11, wherein the second substrate further comprising a color filter layer disposed thereon, the color filter layer being aligned with the reflective region of the first substrate, and the color filter layer being covered with the second electrode layer.

14. The transflective liquid crystal display device according to claim 11, wherein a material of the reflector comprises metal.

15. The transflective liquid crystal display device according to claim 11, wherein the reflector comprises an insulating layer and a metal layer covering the insulating layer.

16. The transflective liquid crystal display device according to claim 11, wherein a light absorbing layer is arranged on the reflective region of the first substrate.

17. The transflective liquid crystal display device according to claim 11, wherein the first substrate further comprises an active device disposed thereon, and the active device is electrically connected to the first electrode layer.

18. The transflective liquid crystal display device according to claim 11, further comprising a first alignment layer and a second alignment layer, the first alignment layer is disposed between the first electrode layer and the cholesteric liquid crystal layer, and the second alignment layer is disposed between the second electrode layer and the cholesteric liquid crystal layer.
